(19) United States
(12) Patent Application Publication
(10) Pub. No.: US 2008/0271448 A1
(43) Pub. Date: Nov. 6, 2008

(54) Particle burner disposed between an engine and a turbo charger

(75) Inventor: Lincoln Evans-Beauchamp, Palo Alto, CA (US)

Correspondence Address: CARR & FERRELL LLP, 2200 GENG ROAD, PALO ALTO, CA, 94303, US

(73) Assignee: EWA Environmental, Inc.

(21) Appl. No.: 11/800,110

(22) Filed: May 3, 2007

(51) Int. Cl. F02B 33/00; F01N 3/00

(52) U.S. Cl. 60/598; 60/300; 60/320

(57) ABSTRACT

A system comprising an engine, a turbo charger, and a particle burner is provided. The particle burner is disposed between the engine and a turbine of the turbo charger. The particle burner receives exhaust from the engine, heats the exhaust to a combustion temperature of particles within the exhaust, and then directs the cleaned exhaust to the turbine. The particle burner can include a reverse flow heat exchanger to heat the exhaust received from the engine. The particle burner can also include a catalyst to catalyze the further combustion of gaseous products of incomplete combustion from within the engine. The heat produced by the further combustion at the catalyst provides a further boost to the temperature within the particle burner.

### CROSS-REFERENCE TO RELATED APPLICATIONS

This application is a continuation-in-part of U.S. patent application Ser. No. ______ filed Apr. 17, 2007 and titled “Particle Burner including a Catalyst Booster for Exhaust Systems,” (attorney docket #PA4141US) which is a continuation-in-part of U.S. patent application Ser. No. 11/404,424 filed Apr. 14, 2006 and titled “Particle Burning in an Exhaust System,” a continuation-in-part of U.S. patent application Ser. No. 11/412,289 filed Apr. 26, 2006 and titled “Air Purification System Employing Particle Burning,” and a continuation-in-part of U.S. patent application Ser. No. 11/412,481 filed Apr. 26, 2006 and titled “Reverse Flow Heat Exchanger for Exhaust Systems.” The disclosures of all of the above U.S. patent applications are hereby incorporated herein by reference.

### BACKGROUND OF THE INVENTION

1. Field of the Invention

This invention relates generally to exhaust systems and more particularly to systems for cleaning exhaust air.

2. Description of the Prior Art

When a fuel burns incompletely, pollutants such as particles and hydrocarbons are released into the atmosphere. The United States Environmental Protection Agency has passed regulations that limit the amount of pollutants that, for example, diesel trucks, power plants, engines, automobiles, and off-road vehicles can release into the atmosphere.

Currently, industries attempt to follow these regulations by adding scrubbers, catalytic converters and particle traps to their exhaust systems. However, these solutions increase the amount of back pressure exerted on the engine or combustion system, decreasing performance. In addition, the scrubbers and particle traps themselves become clogged and require periodic cleaning to minimize back pressure.

Radiation sources and heaters have been used in exhaust systems, for example, to periodically clean the particle traps or filter beds. Others solutions have included injecting fuel into the filter beds or exhaust streams as the exhaust enters the filter beds to combust the particles therein. However, the filter beds can be sensitive to high temperatures and the radiation sources and heaters must be turned off periodically.

Air purification systems currently use one of two methods to remove particles such as dust, biological toxins, and the like from the air in a room. One type of system uses an ionizer to provide a surface charge to the air-borne particles so that they adhere to a surface. However, ionizers emit ozone, a respiratory irritant, into the air. Another type of system uses a filter, such as a HEPA filter, to trap particles as the air flows through the filter. However, filters need to be replaced or cleaned periodically. Both methods require a fan to circulate the air, which requires electricity and can be loud.

Catalyst systems reduce a toxicity of emissions from an internal combustion engine by providing an environment for a chemical reaction wherein toxic combustion by-products are converted to less-toxic substances. Some of the reactions may include oxidizing carbon monoxide to carbon dioxide, oxidizing unburnt hydrocarbons to carbon dioxide and water, and reducing nitrogen oxides to nitrogen and oxygen. These reactions have a net exothermic effect. Conventional catalysts system dump heat generated from the exothermic reaction into the environment.

### SUMMARY OF THE INVENTION

An exhaust system comprises a combustion chamber and a radiation source. The radiation source is arranged with respect to the combustion chamber, either inside or outside of the chamber, so as to be able to produce radiation within the combustion chamber. The radiation source can comprise a resistive heating element, a coherent or incoherent infrared emitter, or a microwave emitter, for example. The microwave emitter can be tuned to a particular molecular bond. Where the radiation source is disposed outside of the combustion chamber, the radiation source can either heat the chamber walls to reradiate into the chamber, else the combustion chamber can include a radiation transparent window.

Particles in an exhaust stream passing through the combustion chamber are heated by the radiation to an ignition point and are consequently removed from the exhaust by burning. Microwave radiation tuned to excite a molecular bond found in the particles can be particularly effective for heating the particles rapidly. Additional air or fuel can be added to the combustion chamber, as needed, to promote better combustion. Once a flame front is established in the combustion chamber, the combustion reaction can become self-sustaining so that further radiation from the radiation source is no longer required.

In some embodiments, the combustion chamber has a non-circular cross-section perpendicular to a longitudinal axis of the chamber. In some of these embodiments, the cross-section is at least partially parabolic to focus heat from the burning particles back into a hot zone within the combustion chamber where the particle burning preferentially occurs. The combustion chamber can be thermally insulated to better retain heat in order to maintain the combustion reaction. The exhaust system can also comprise a thermally insulated exhaust pipe leading to the combustion chamber to further reduce the loss of heat from the exhaust stream before particle burning can occur. In some embodiments, a reverse flow heat exchanger is placed in fluid communication with the combustion chamber so that heat is transferred to the incoming exhaust stream from the combusted exhaust stream exiting the combustion chamber. In certain embodiments, the reverse flow heat exchanger is also thermally insulated.

One advantage of certain embodiments of the present invention is the absence of a particle filter or trap within the combustion chamber. While prior art systems have attempted to trap particles and then periodically clean the trap or filter, these systems create significant back-pressure as such traps and filters obstruct the exhaust flow, especially as they become plugged with particles. Continuously burning the particles in the combustion chamber without the use of such traps or filters provides a more simple design that additionally reduces back-pressure.

A vehicle comprising an internal combustion engine and the exhaust system described above is also provided. The exhaust system can serve as either or both of a muffler and a catalytic converter. Thus, the combustion chamber can also include a catalyst. In some embodiments, the combustion chamber and/or the reverse flow heat exchanger can be sized to act as a resonating chamber to serve as a muffler. For example, the combustion chamber can have a diameter greater than a diameter of the exhaust pipe leading into the combustion chamber. The vehicle can also comprise a controller configured to control the radiation source.

The system described herein can be implemented in a variety of settings where particles are present in a gas stream. Some embodiments include automobile exhaust systems, diesel exhaust systems, power plant emission systems, fireplace chimneys, off-road vehicle exhaust systems, and the like.

An air purification system comprises a spiral reverse flow heat exchanger, including two ducts, spiral-wound around a combustion chamber. The reverse flow heat exchanger draws particle-laden air into the combustion chamber. In the combustion chamber, the particles are burned, which heats the air. The exiting air, substantially particle-free, exits the combustion chamber at an elevated temperature. The reverse flow heat exchanger transfers the heat from the exiting air to preheat the particle-laden air entering the combustion chamber.

In some embodiments, a radiation source is arranged with respect to the combustion chamber so as to produce radiation within the chamber. The radiation source can be, for example, a microwave emitter tuned to excite a molecular bond. The radiation heats the particles sufficiently to initiate a complete combustion reaction.

In other embodiments, a flame is used to burn the particles in the combustion chamber. Accordingly, the combustion chamber includes a fuel inlet and an igniter to light the flame. Suitable fuels include propane and butane. A flame can also be used in combination with the radiation source.

An exhaust system comprises a reverse flow heat exchanger including a plate defining a plane and separating an exit chamber and an intake chamber. Each chamber of the heat exchanger has an inlet and an outlet located at opposing ends to allow flow therethrough. The exhaust system also comprises a first manifold coupled to the reverse flow heat exchanger and in fluid communication with the intake chamber inlet. A vane disposed within the first manifold is situated relative to the intake chamber inlet so as to reduce resistance to fluid flow near the intake chamber inlet. The exhaust system can also comprise a heating manifold that receives exhaust from the intake chamber, heats the exhaust, and returns the exhaust to the exit chamber. In some embodiments, the heating manifold is a combustion chamber for burning particles in the exhaust. In these embodiments the exhaust system can also comprise a radiation source for heating the particles to at least an ignition temperature.

Another exemplary exhaust system comprises a first manifold and a reverse flow heat exchanger coupled to the first manifold. Here, the reverse flow heat exchanger defines a transverse plane and includes a plurality of parallel plates separating a number of chambers, each chamber having an inlet and an outlet. These chambers comprise a set of intake chambers alternating with a set of exit chambers, where the inlets of the intake chambers being in fluid communication with the first manifold and the outlets of the intake chambers being in fluid communication with the inlets of the exit chambers. The exhaust system can further comprise a heating manifold coupled to the reverse flow heat exchanger to provide the fluid communication between the outlets of the intake chambers and the inlets of the exit chambers.

An exemplary exhaust cleaner comprises a reverse flow heat exchanger and a gas permeable catalyst. The reverse flow heat exchanger includes a first duct interleaved with a second duct, where each duct is spiral-wound around a central volume. The first and second ducts are also in fluid communication with each other across the central volume. The gas permeable catalyst is disposed within the central volume and separates the central volume into first and second regions. The first duct of the reverse flow heat exchanger opens into the first region, and the second duct of the reverse flow heat exchanger opens into the second region. In some embodiments, the catalyst comprises a substrate and a catalytic material. Additionally, the central volume can further comprise a heating element or a radiation source.

An exemplary vehicle comprises an internal combustion engine and an exhaust system configured to receive exhaust from the internal combustion engine. The exhaust system includes an exhaust cleaner comprising a reverse flow heat exchanger and a gas permeable catalyst. The reverse flow heat exchanger includes a first duct interleaved with a second duct, where each duct is spiral-wound around a central volume. The first and second ducts are also in fluid communication with each other across the central volume. The gas permeable catalyst is disposed within the central volume and separates the central volume into first and second regions. The first duct of the reverse flow heat exchanger opens into the first region, and the second duct of the reverse flow heat exchanger opens into the second region. In some of these embodiments, the exhaust cleaner further comprises an inlet chamber and an outlet chamber, wherein the inlet chamber is in fluid communication with the first duct and the outlet chamber is in fluid communication with the second duct. The inlet chamber can include vanes that protrude into the inlet chamber, and the outlet chamber can include vanes extending outward.

An exemplary method for cleaning vehicle exhaust is also provided. The method comprises heating exhaust from an internal combustion engine in a first duct of a reverse flow heat exchanger, passing the exhaust from the first duct, through a gas permeable catalyst, and into a second duct of the reverse flow heat exchanger, where catalysis of incomplete combustion products at the catalyst heats the catalyst and further heats the exhaust, and cooling the exhaust within the second duct by transferring heat to the first duct. Here, the ducts of the reverse flow heat exchanger can be interleaved and/or spiral-wound. The method can also comprise monitoring a temperature of the catalyst. In some of these embodiments, the method further comprises employing a heating means to heat the exhaust whenever the temperature of the catalyst is below a threshold.

Yet another exemplary system of the invention comprises an engine, a turbo charger including an impeller and a turbine, and a particle burner disposed between the engine and the turbine and configured to receive exhaust from the engine. The system can comprise a vehicle or a stationary system such as a power plant, for example. The engine can be a diesel engine or a gasoline engine, in some embodiments.

Yet another exemplary method comprises burning fuel in an engine to produce an exhaust including particles, using the exhaust to drive a turbine of a turbo charger, and heating the exhaust to a combustion temperature of the particles before using the exhaust to drive the turbine. In some embodiments, heating the exhaust includes generating heat by catalyzing the further combustion of gaseous products of incomplete combustion. Heating the exhaust can also include passing the exhaust through a reverse flow heat exchanger. The reverse flow heat exchanger can comprise two interleaved ducts, and in some instances the ducts are spiral-wound.

### BRIEF DESCRIPTION OF THE FIGURES

FIG. 1 depicts a system for burning particles in an exhaust system in accordance with one embodiment of the invention.

FIG. 2 depicts a system for burning particles in an exhaust system in accordance with another embodiment of the invention.

FIG. 3 depicts a system for burning particles in an exhaust system in accordance with another embodiment of the invention.

FIG. 4 depicts a system for burning particles in an exhaust system in accordance with another embodiment of the invention.

FIG. 5 depicts a cross sectional view of the system for burning particles further comprising a reverse flow heat exchanger in accordance with one embodiment of the invention.

FIG. 6 depicts a schematic representation of a vehicle comprising an internal combustion engine and an exhaust system in accordance with another embodiment of the invention.

FIG. 7 depicts a cross sectional view taken perpendicular to a vertical axis of an exemplary spiral reverse flow heat exchanger and combustion chamber in an air purification system in accordance with one embodiment of the invention.

FIG. 8 depicts a cross sectional view along a vertical axis of the air purification system in accordance with one embodiment of the invention.

FIG. 9 is a flow chart depicting a method for purifying air in accordance with one embodiment of the invention.

FIGS. 10 and 11 depict top and front views, respectively, of an exemplary system for burning particles in an exhaust system in accordance with an embodiment of the invention.

FIGS. 12 and 13 depict cross sections of the intake chamber and exit chamber, respectively, of the system shown in FIGS. 10 and 11.

FIG. 14 depicts a cross section taken along the line 14-14 of FIG. 11.

FIG. 15 depicts a cross section taken along the line 15-15 of FIG. 11.

FIG. 16 depicts a cross section taken along the line 16-16 of FIG. 10.

FIGS. 17 and 18 depict top and front views, respectively, of an exemplary system for burning particles in an exhaust system in accordance with another embodiment of the invention.

FIGS. 19 and 20 depict cross sections of the intake chamber and exit chamber, respectively, of the system shown in FIGS. 17 and 18.

FIG. 21 depicts a cross section taken along the line 21-21 of FIG. 17 with several alternative implementations of a vane.

FIG. 22 depicts a cross section taken along the line 22-22 of FIG. 17.

FIG. 23 depicts a cross sectional view taken perpendicular to a vertical axis of an exemplary reverse flow heat exchanger and catalyst in an exhaust system in accordance with still another embodiment of the invention.

FIGS. 24 and 25 show top and side views, respectively, of an exemplary exhaust system in accordance with an embodiment of the invention.

FIG. 26 depicts a cross section of an exhaust system taken along line 26-26 of FIG. 25.

FIG. 27 depicts a schematic representation of a particle burner disposed between an engine and a turbo charger according to an exemplary embodiment of the invention.

### DETAILED DESCRIPTION

An exhaust system comprises a combustion chamber and a radiation source to facilitate the combustion of particles within the chamber. Once ignited, the combustion can continue so long as the concentration of particles in the exhaust entering the chamber remains sufficiently high. The disclosed device can replace both the muffler and the catalytic converter in a vehicle exhaust system and offers reduced back pressure for better fuel economy and lower maintenance costs. The device requires little to no maintenance and is self-cleaning.

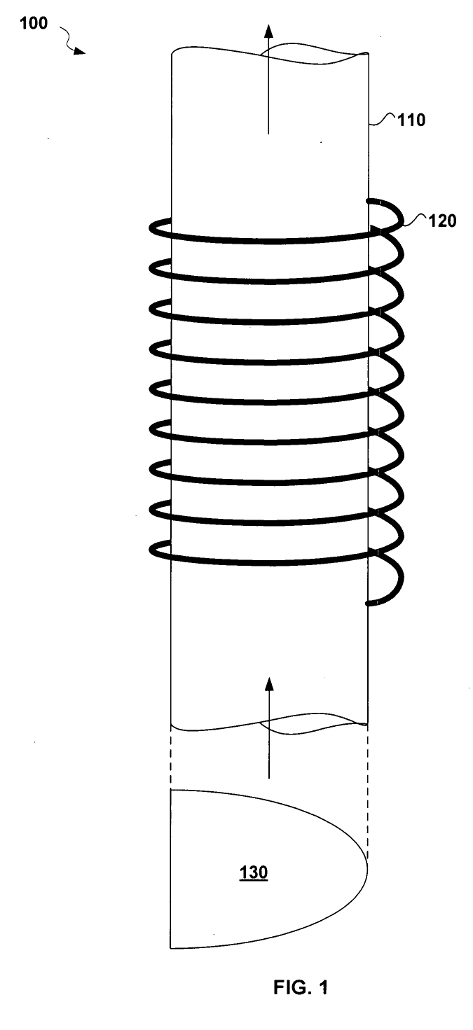

FIG. 1 depicts an exhaust system 100 comprising a combustion chamber 110 and a radiation source 120. The combustion chamber 110 can be constructed using any suitable material capable of withstanding the exhaust gases at the combustion temperature of the particles. Suitable materials include stainless steel, titanium, and ceramics. In one embodiment, the combustion chamber 110 has a non-circular cross-section 130 perpendicular to a longitudinal axis of the combustion chamber 110. At least a portion of the cross-section 130 can be parabolic in order to focus radiation from the combustion reaction into a hot zone within the combustion chamber 110. It will be appreciated that the combustion chamber 110, in some embodiments, can be proportioned to serve as a resonating chamber so that the combustion chamber 110 also performs as a muffler.

One advantage of certain embodiments of the present invention is the absence of an obstructing particle filter or trap within the combustion chamber 110. A particle trap or filter is obstructing if it would at least partially restrict the flow of an exhaust gas through the combustion chamber 110. By not restricting the flow of exhaust gas through the combustion chamber 110, embodiments of the invention serve to reduce back-pressure compared with prior art systems.

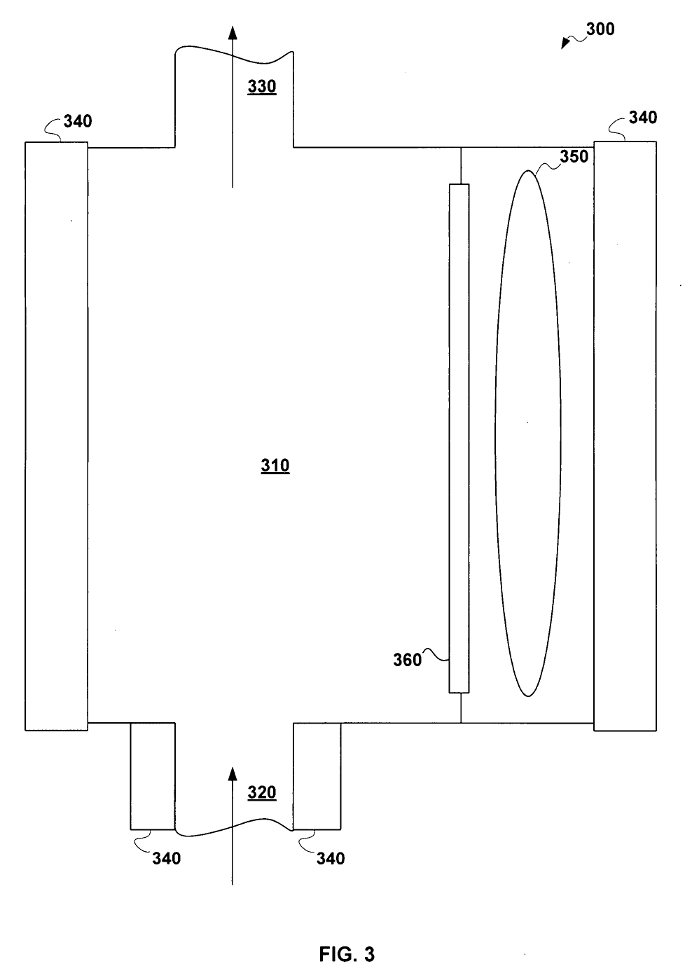

Radiation source 120, in the illustrated embodiment, comprises a resistive heating element wrapped around the outside of the combustion chamber 110. In another embodiment, the radiation source 120 is placed externally along the longitudinal length of the combustion chamber 110. In some embodiments, a controller (not shown) for the radiation source 120 is provided to control the power to the radiation source 120 and to turn off the radiation source 120 when not needed, such as when no exhaust is flowing. Alternative radiation sources are discussed below with reference to FIG. 3.

In operation, an exhaust gas containing particles, such as carbonaceous particles like soot, flows through the combustion chamber 110. The radiation source 120 heats the wall of the combustion chamber 110 which re-radiates infrared (IR) radiation into the interior of the combustion chamber 110. Some of the IR radiation is absorbed by the particles in the exhaust gas as they traverse the combustion chamber 110. When the particles reach a temperature at which they ignite, about 800° C. for carbonaceous particles, the particles burn completely, leaving no residue. Accordingly, essentially particle-free exhaust leaves the combustion chamber 110.

The heat produced by the combustion of the particles can make the continuing reaction self-sustaining so that the radiation source 120 is not necessary. A thermocouple (not shown) can be placed on or in the combustion chamber 110 in order to monitor the temperature of the combustion reaction to provide feedback to a controller (not shown) for controlling the power to the radiation source 120. As noted above, the combustion chamber 110 can be shaped to focus IR radiation from the combustion reaction onto a focal point or line within the combustion chamber 110 to create a hot zone that helps to sustain the continuing reaction in the absence of external heating.

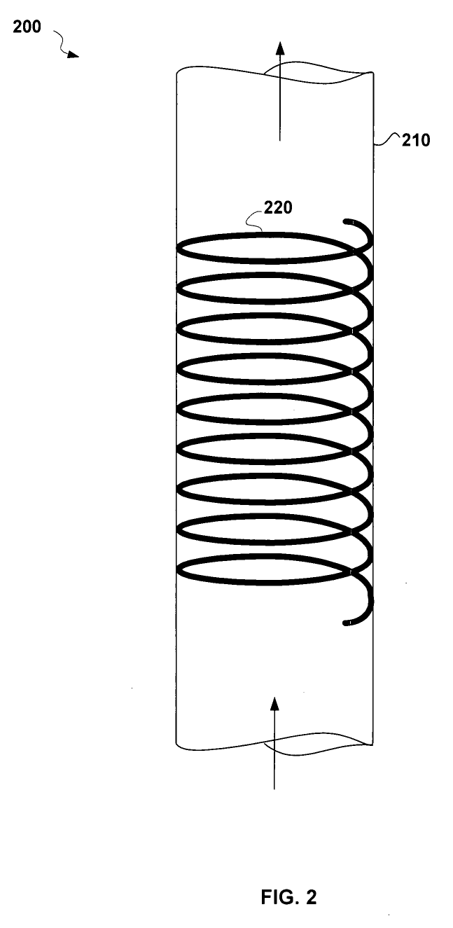

FIG. 2 depicts an exhaust system 200 comprising a combustion chamber 210 and a radiation source 220. In exhaust system 200, the radiation source 220 is disposed within the combustion chamber 210. The radiation source 220, as shown, comprises a coiled resistive heating element. As above, the radiation source 220 can take other shapes and, for example, can be longitudinally disposed internally along the length of the combustion chamber 210. In those embodiments in which the radiation source 220 is disposed within the combustion chamber 210, radiation from the radiation source 220 can directly heat the particles in the exhaust as well as heat the walls of the combustion chamber 210 as in the embodiment of FIG. 1. While the direct heating of the particles is more energy efficient, placing the radiation source 220 within the combustion chamber 210 disadvantageously exposes the radiation source 220 to the high-temperature exhaust gases.

FIG. 3 depicts an exhaust system 300 comprising a combustion chamber 310 having an inlet 320 and an outlet 330, optional thermal insulation 340, a radiation source 350, and a radiation transparent window 360 into the combustion chamber 310. In the illustrated embodiment, a diameter of the combustion chamber 310 is greater than a diameter of the inlet 320. This arrangement slows the exhaust gas as it enters the combustion chamber 310 and can create a muffling effect.

In some embodiments, the inlet 320 and/or the combustion chamber 310 are thermally insulated by the thermal insulation 340 to retain as much heat as possible in the exhaust gas as the gas enters the combustion chamber 310. It will be appreciated that insulation 340 can be similarly applied to the other embodiments disclosed herein. For example, a blanket of insulation 340 can be wrapped around the radiation source 120 and combustion chamber 110 of FIG. 1.

Radiation source 350 can be, for example, a coherent or incoherent IR emitter or microwave emitter, such as a Klystron tube. Unlike a resistive heating element, radiation source 350 can be configured to emit radiation directionally and/or within a desired range of wavelengths. Accordingly, radiation transparent window 360 is provided to allow radiation to pass directly into the combustion chamber 310. In some embodiments, the radiation transparent window 360 extends completely around the circumference of the combustion chamber 310.

As noted, radiation source 350 can be tuned to produce radiation within a desired range of wavelengths. Thus, the radiation can be tuned to excite specific molecular bonds that are known to be present in the particles of the exhaust stream. For example, microwave radiation can be tuned to excite carbon-hydrogen bonds or carbon-carbon bonds where the particles in the exhaust are known to include such bonds. Tuning the radiation in this manner can heat particles to their ignition temperature more quickly and with less energy.

The radiation transparent window 360 is constructed using a material that can withstand the heated exhaust gases within the combustion chamber 310. In some embodiments, radiation transparent window 360 is a microwave transparent window constructed using fiberglass, plastic, polycarbonate, quartz, porcelain, or the like. In other embodiments, the radiation transparent window 360 is an IR transparent window constructed using, for instance, sapphire.

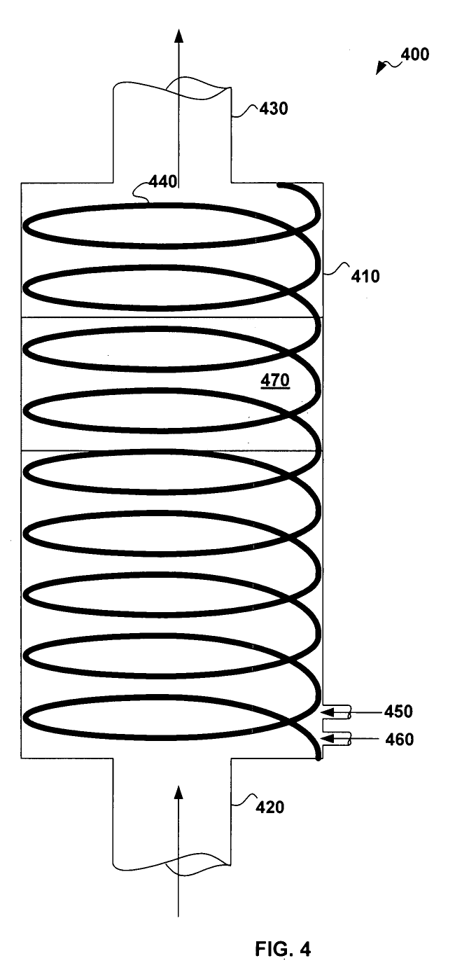

FIG. 4 depicts an exhaust system 400 to illustrate other optional components that can be employed in conjunction with any of the preceding embodiments. Exhaust system 400 comprises a combustion chamber 410 having an inlet 420 and an outlet 430, a radiation source 440, an air inlet 450, a fuel inlet 460, and a catalyst 470. As in the previous example, the combustion chamber 410 can have a greater diameter than the inlet 420 and the outlet 430. Alternatively, the outlet 430 can have the same diameter as combustion chamber 410. The radiation source 440, as shown, is a resistive heating element disposed within the combustion chamber 410, but can alternatively be disposed externally and can alternatively be an IR or microwave emitter.

The combustion chamber 410 may comprise air intake 450 and/or fuel intake 460. In some embodiments, air intake 450 is configured to introduce oxygen to the combustion chamber to aid the combustion reaction in the event that there is not enough oxygen present in the exhaust as it enters the combustion chamber 410. In other embodiments, fuel intake 460 introduces fuel into the combustion chamber to burn and, thus, heat the exhaust as it enters through inlet 420. It will be appreciated that adding fuel with or without air can, in some instances, replace the need for a radiation source. In such embodiments, a spark generator or other ignition source can be employed to ignite the combustion reaction with the added fuel.

In certain embodiments, the combustion chamber 410 additionally comprises at least one catalyst 470 to catalyze oxidation and/or reduction reactions in the exhaust stream. The catalyst 470 can include platinum, rhodium, and/or palladium deposited on a honeycomb substrate or ceramic beads. In these embodiments, the combustion chamber 410 is configured to additionally function as a catalytic converter in the exhaust system 400. It will be understood that heating the exhaust gas in the presence of the catalyst 470 can advantageously improve the completeness of the reaction being catalyzed.

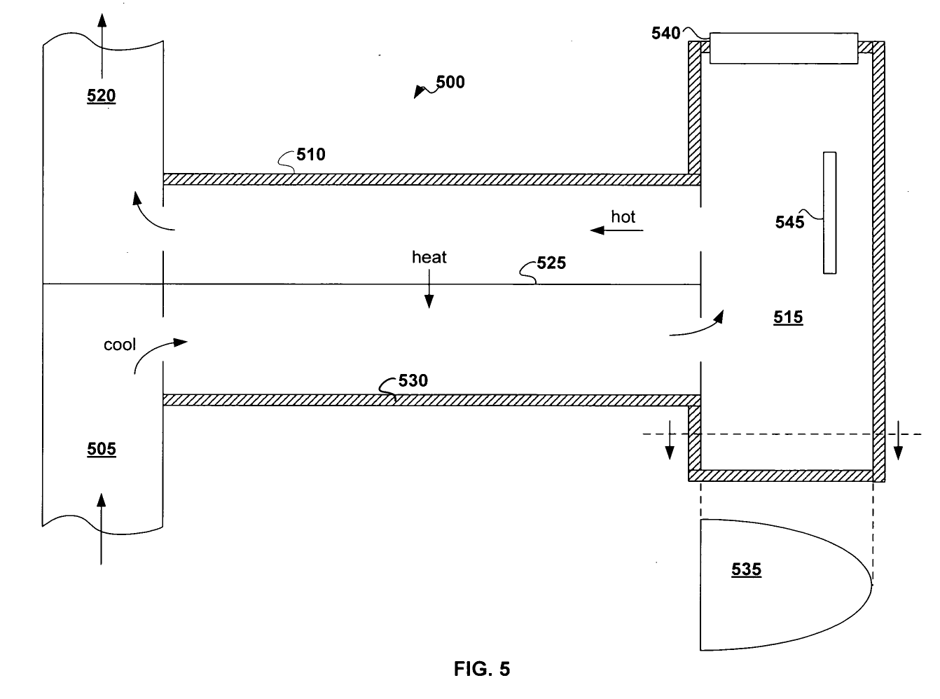

FIG. 5 depicts an exhaust system 500 comprising an inlet 505, a heat exchanger 510, a combustion chamber 515, and an outlet 520. The heat exchanger 510 serves to pre-heat the exhaust before the exhaust enters the combustion chamber 515. The heat exchanger 510 can also serve as a muffler, in some embodiments. Heat exchanger 510 is separated into two or more sections by at least one wall 525. Exhaust enters the exhaust system 500 via the inlet 505 and is directed into one section of the heat exchanger 510. Heated gases exiting the combustion chamber 515 through another section of the heat exchanger 510 transfer heat to the incoming gases through the wall 525. In some embodiments, the heat exchanger 510 and/or the combustion chamber 515 are insulated by thermal insulation 530. As in other embodiments described herein, the inlet 505 can also be thermally insulated.

In some embodiments, the combustion chamber 515 has a parabolic or partially parabolic cross-section 535 perpendicular to a longitudinal axis to create a hot zone. The combustion chamber 515 also comprises a radiation source 540. In some embodiments, the radiation source 540 is a microwave emitter, such as a Klystron tube. Alternatively, radiation source 540 is an IR emitter. In some embodiments, a radiation transparent window separates the radiation source 540 from the combustion chamber 515.

In some embodiments, the combustion chamber 515 further comprises at least one catalyst 545 configured to catalyze oxidation and/or reduction reactions of undesirable gases in the exhaust stream such as NOₓ compounds. In those embodiments where the heat exchanger 510 is configured to act as a muffler, and the combustion chamber 515 comprises catalyst 545, it will be appreciated that the exhaust system 500 can replace both the muffler and the catalytic converter in a conventional vehicle exhaust system. Advantageously, because the combustion chamber 515 burns the particles present in the exhaust stream, it will be further appreciated that the exhaust system 500 can additionally replace a particle trap in a conventional vehicle exhaust system. One of skill in the art will also recognize that the exhaust systems disclosed herein can also be applied to clean exhaust streams from non-vehicular sources such as power plants, fireplace chimneys, industrial and commercial processing, and the like.

It should be noted that in some embodiments the catalyst 545 comprises a substrate, such as a grating, with a surface coating of a catalytic material that is placed over an opening 550 of the heat exchanger 510. While such a catalyst 545 may at least partially restrict the flow of exhaust gas through the combustion chamber 515, the catalyst is not a particle trap or filter. Specifically, openings in the grating are too large to trap or filter the particles in the exhaust entering the chamber 515. Additionally, such a catalyst 545 cannot collect particles for two reasons. First, particles are eliminated from the exhaust before the exhaust reaches the opening 550. Second, even if a particle survives the combustion reaction and adheres to the catalyst 545, the restriction around the particle would cause a local increase in temperature which would cause the particle to burn and not be retained thereon.

Likewise, some embodiments that employ a microwave emitter as the radiation source 540 include a microwave-blocking grating (not shown) either across the opening 550 or further downstream along the exhaust path to prevent microwaves from propagating out of the exhaust system 500. For essentially the reasons discussed above, although such a microwave-blocking grating may at least partially restrict the flow of exhaust gas through the combustion chamber 515, the microwave-blocking grating is not a particle trap or filter. The openings of the grating are too large to trap or filter particles in the exhaust, particles are eliminated from the exhaust before the exhaust reaches the microwave-blocking grating, and any particles that survive and adhere to the microwave-blocking grating simply burn off.

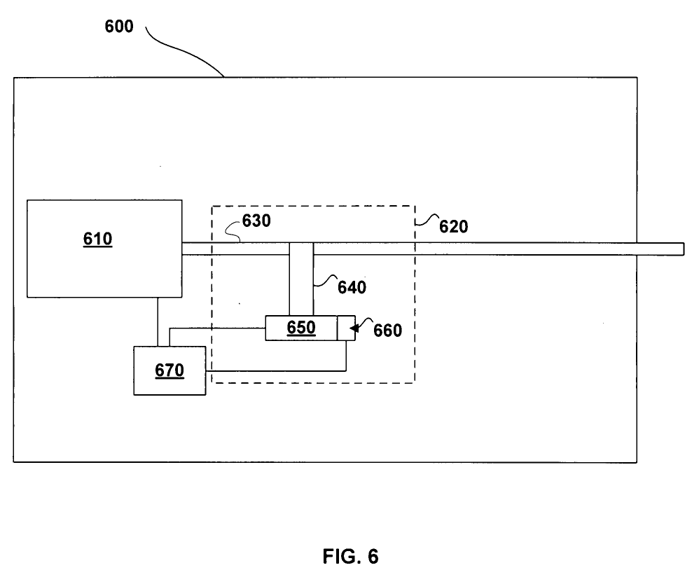

FIG. 6 shows a schematic representation of a vehicle 600 comprising an internal combustion engine 605 such as a diesel engine. The vehicle 600 also comprises an exhaust system 610 that includes an exhaust pipe 615 from the engine 605 to a reverse flow heat exchanger 620, a combustion chamber 625, and a radiation source 630. The vehicle 600 further comprises a controller 635 for controlling the power to the radiation source. The controller 635 can be coupled to the engine 605 so that no power goes to the radiation source 630 when the engine is not operating, for example. The controller 635 can also control the radiation source 630 in a manner that is responsive to engine 605 operating conditions. Further, the controller 635 can also control the radiation source 630 according to conditions in the combustion chamber 625. For instance, the controller 635 can monitor a thermocouple in the combustion chamber 625 so that no power goes to the radiation source 630 when the temperature within the combustion chamber 625 is sufficiently high to maintain a self-sustaining combustion reaction.

An additional embodiment of the invention is an air purifier such as for a hospital room, a clean room, a factory, an office, a residence, or the like. An exemplary air purification system comprises a combustion chamber and a means for heating particles in the air to at least an ignition temperature within the chamber. A reverse flow heat exchanger is wrapped around the combustion chamber to recycle excess heat from the exiting air to the entering air. The means for heating can be a radiation source, an open flame, or both.

Unlike the exhaust systems described previously herein, these embodiments are designed for environments in which the concentration of particles in the incoming air is low. Therefore, in embodiments that employ a radiation source, the radiation source is typically run constantly to maintain the combustion of the particles. Additionally, or alternatively, a fuel can be supplied to the combustion chamber to compensate for the lower concentration of particles. Like the prior exhaust systems, this further air purifier requires little to no maintenance and is self-cleaning. Advantageously, some embodiments of the air purifier do not require a radiation source or a fan to maintain air movement and therefore do not require electricity.

FIG. 7 depicts a cross sectional view of an air purification system 700. The cross section depicted is taken perpendicular to a vertical axis of the air purification system 700. A reverse flow heat exchanger 710 comprises two ducts, an incoming duct 720 and an outgoing duct 730 coiled around a combustion chamber 740. The air purification system 700 also comprises an inlet 750 and an outlet 760 shown in dashed lines to represent that these components are out of the plane of the drawing. The inlet 750 is an opening through which particle-laden air enters the incoming duct 720 of the reverse flow heat exchanger 710. The outlet 760 is an opening through which substantially particle-free air leaves the outgoing duct 730 of the reverse flow heat exchanger 710. Typically, the reverse flow heat exchanger 710 and the combustion chamber 740 are constructed using stainless steel, but other suitable materials will be familiar to those skilled in the art.

The reverse flow heat exchanger 710 transfers heat from the air exiting the combustion chamber 740 to the particle-laden air entering the combustion chamber 740. After the particle-laden air enters the combustion chamber 740, the particles are burned and the air exits the combustion chamber 740 substantially particle-free. As particles, including dust, biological toxins, and the like, typically combust at about 800° C., the exiting air is significantly warmer than room temperature. The excess heat is transferred from the exiting air to the entering air through the walls of the reverse flow heat exchanger 710 to preheat the particle-laden air. The heat exchanger 710 also acts as insulation for the combustion chamber 740, making the air purification system 700 safer and more energy efficient.

In some embodiments, an optional fan (not shown), can be placed at the inlet 750 and/or the outlet 760 to improve air flow through the air purification system 700. At the outlet 760, for instance, the fan draws air out from the air purification system 700. The fan can be run continuously, periodically, or when the air purification system 700 is first activated. The fan can be connected to a control circuit described herein.

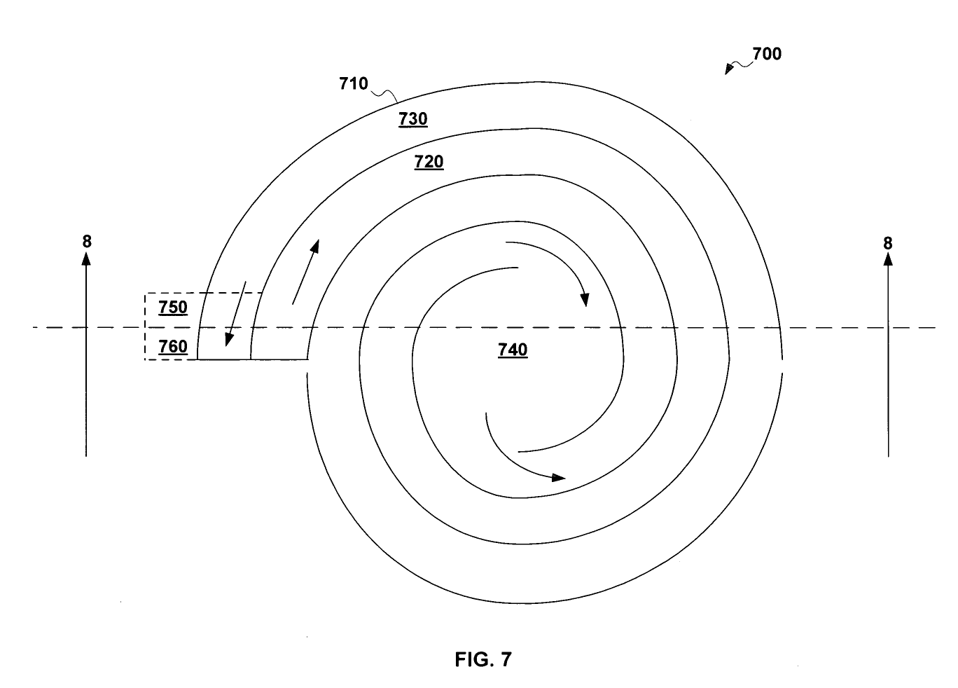

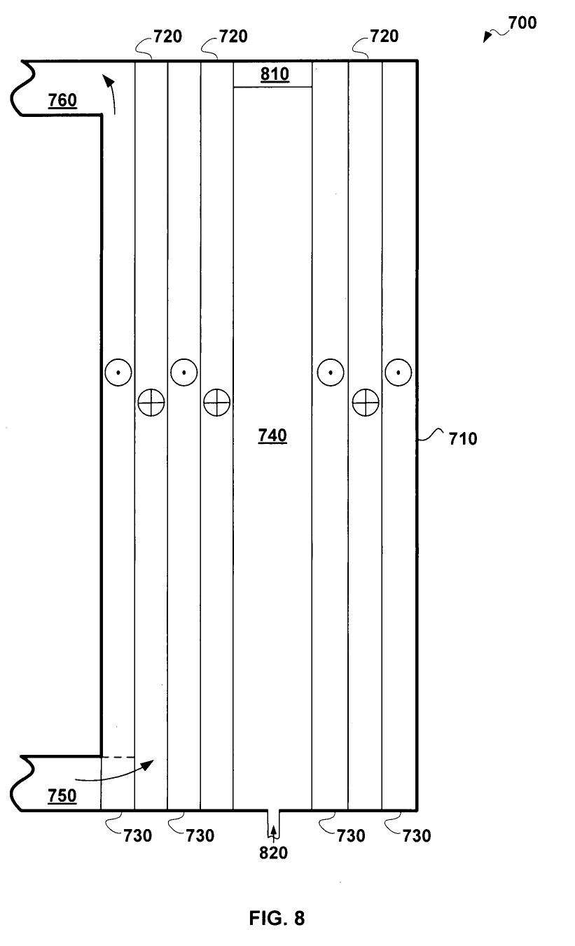

FIG. 8 depicts a cross sectional view of the air purification system 700 along a line 8-8 as noted in FIG. 7. The reverse flow heat exchanger 710 includes an inlet 750 and an outlet 760. An incoming duct 720 is depicted using an arrow pointing into the page. An outgoing duct 730 is depicted using an arrow pointing out of the page. The inlet 750 and the outlet 760 are typically located at opposite ends of the air purifier 700.

In some embodiments, the air purification system 700 has a height dimension approximately equal to the height of a room in which the air purification system 700 will be installed. Accordingly, the inlet 750 can be near the floor while the outlet 760 can be near the ceiling, or vice-versa. This height ensures that most of the air in the room circulates through the air purification system 700. Other dimensions, including the number of windings, the spacings between the walls, and the like can be determined by one skilled in the art.

The air purification system 700 also includes means for heating particles. The means for heating particles can be disposed near the top of the combustion chamber 740 or in another location, such as the bottom of the combustion chamber 740. The means for heating particles heats the particles in the combustion chamber 740 to at least an ignition temperature. The air purification system 700 may additionally include a control circuit (not shown) to monitor and control the combustion and flow rate through the air purification system 700.

The means for heating particles can be a radiation source 810, an open flame, or both. For example, as a radiation source 810, the means can be a microwave emitter such as a Klystron tube. The radiation can be tuned to excite specific molecular bonds that are known to be present in the particles in the air. For example, microwave radiation can be tuned to excite carbon-hydrogen bonds or carbon-carbon bonds where the particles in the exhaust are known to include such bonds. Tuning the radiation in this manner can heat particles to their ignition temperature more quickly and with less energy. As described herein, for example in the description of FIG. 3, the microwave emitter can be positioned behind a microwave transparent window. The radiation source 810 can also be a resistive heating element such as radiation source 120 (FIG. 1) vertically disposed within the combustion chamber 740. In some embodiments, such a resistive heating element is a straight length running the height of the combustion chamber 740, rather than the coil depicted in FIG. 1.

Alternatively, the means for heating particles can be a flame. The flame is fueled by fuel entering the combustion chamber 740 via a fuel inlet 820 positioned to inject fuel into the bottom of the combustion chamber 740. Suitable fuels include clean-burning fuels such as propane and butane. The flame is ignited by an igniter (not shown) and burns continuously to heat the particles and the walls of the combustion chamber 740.

The air turnover rate in a room can be varied as needed. An appropriate rate will depend on factors such as the size of the room, air cleanliness requirements for the room, energy efficiency, and the like. For example, in a hospital room or an industrial clean room, where very clean air is required, the air turnover rate can be set significantly higher than in an office where energy efficiency can be more important. The turnover rate can be increased by increasing the flow rate through the air purifier, for example, by increasing the rate at which fuel is burned.

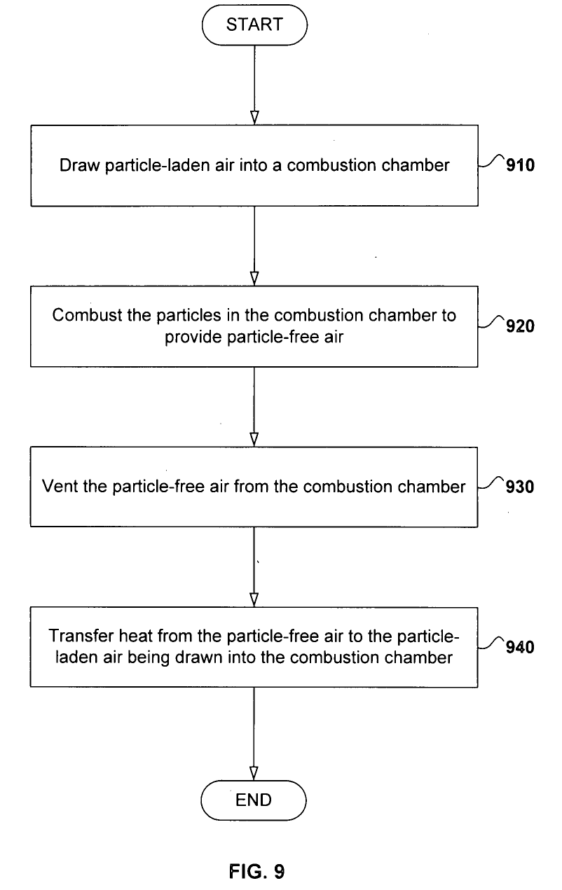

FIG. 9 is a flowchart depicting a method for purifying air. In a step 910, particle-laden air is drawn into a combustion chamber, e.g. combustion chamber 740. The particle-laden air can be drawn in behind the heated rising air in the combustion chamber 740 or by, for example, a fan. In step 920, the particles in the combustion chamber 740 are combusted to provide particle-free air. The combustion reaction is caused by radiation within the combustion chamber 740. A fuel source, such as a propane or butane source can be in fluid communication with the fuel inlet 820. As the fuel mixed with the particle-laden air combusts, the reaction creates heat, further heating other particles to a combustion point. After the combustion reaction, the particle-laden air is substantially particle-free.

In step 930 the particle-free air is vented from the combustion chamber 740. As the heated particle-free air rises and expands, it establishes a circulation through the air purification system 700 which forces the particle-free air out of the combustion chamber 740 and through the outgoing duct 730, venting the air. Additionally, a fan can assist the venting of the air. In step 940, heat from the particle-free air is transferred to the particle-laden air being drawn into the combustion chamber 740. This step can be performed using, e.g. heat exchanger 710. By transferring heat from the particle-free air to the particle-laden air, the particle-laden air is pre-heated prior to combustion which results in greater overall energy efficiency.

Another embodiment of the invention is directed to an exhaust system. This exhaust system comprises a reverse flow heat exchanger coupled to a means for heating the exhaust gas, such as a combustion chamber for burning particles carried by the exhaust gas. The reverse flow heat exchanger recovers heat from the exhaust gas after passing through the heating means and transfers the heat to the exhaust gas entering the heating means. The heat recovery increases the energy efficiency of the exhaust system and provides further advantages as described below.

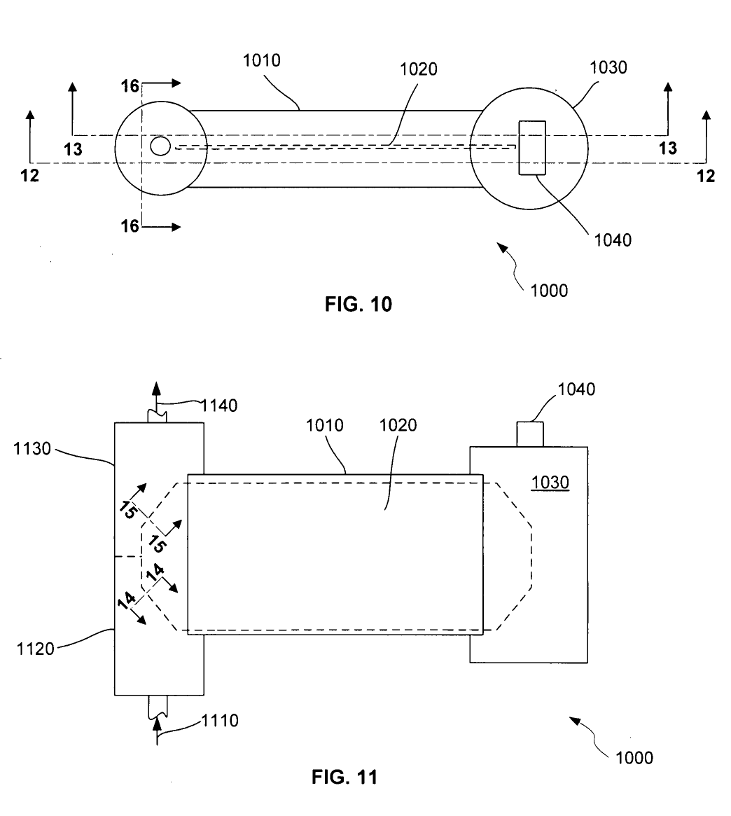

FIGS. 10 and 11 show top and front views, respectively, of an exemplary exhaust system 1000. The exhaust system 1000 is generally applicable and can be included, for example, as part of a vehicle, a power plant, or a fireplace. The embodiment depicted in FIGS. 10 and 11 comprises a reverse flow heat exchanger 1010 including two chambers separated by a plate 1020 (shown in dashed lines to indicate that the plate is internal to the heat exchanger 1010). One chamber of the heat exchanger 1010 is in fluid communication between a first manifold 1120 and a combustion chamber 1030. A second chamber of the heat exchanger 1010 is in fluid communication between the combustion chamber 1030 and a second manifold 1130. The chambers within the heat exchanger 1010 are described in greater detail below. The heat exchanger 1010 including the plate 1020, the combustion chamber 1030, and the manifolds 1120, 1130 can be constructed using any suitable material capable of withstanding the exhaust gases at the operating temperature of the exhaust system 1000. Suitable materials include stainless steel, titanium, and ceramics. The plate 1020 should be constructed of a material with high thermal conductivity, such as a metal, to provide good heat transfer between the chambers.

In operation, exhaust gas 1110 from a source such as a diesel engine enter the manifold 1120 and are directed through the heat exchanger 1010 to the combustion chamber 1030. In the illustrated embodiment, particles within the exhaust are burned in the combustion chamber 1030, significantly increasing the temperature of the exhaust gas. Combustion of the particles is facilitated by a radiation source 1040 attached to the combustion chamber 1030.

The heated exhaust gas 1140 exits the combustion chamber 1030, passes back through the heat exchanger 1010, and leaves the exhaust system 1000 through the manifold 1130. In the heat exchanger 1010, heat from the hot gas 1140 exiting the combustion chamber 1030 is transferred to the incoming exhaust gas 1110 from the manifold 1120 through the plate 1020. By using the residual heat of the combustion of the particles to heat the incoming exhaust gas 1110, the exhaust system 1000 utilizes less energy. Other advantages of the heat exchanger 1010 are discussed herein.

It will be appreciated that although the illustrated embodiment in FIGS. 10 and 11 includes a combustion chamber 1030, the present invention is not limited to exhaust systems including combustion chambers. While the heat exchanger 1010 needs to be coupled to some heating source to raise the temperature of the exhaust gas, the combustion chamber 1030 is merely one example. The combustion chamber 1030 can be replaced, for example, with a catalytic converter comprising a catalytic material supported on a substrate that is heated by a resistive heating element. In general terms, the combustion chamber 1030 is an example of a heating manifold that heats the exhaust gas from the intake chamber 1210 of the heat exchanger 1010 and returns it to the exit chamber 1310 of the heat exchanger 1010.

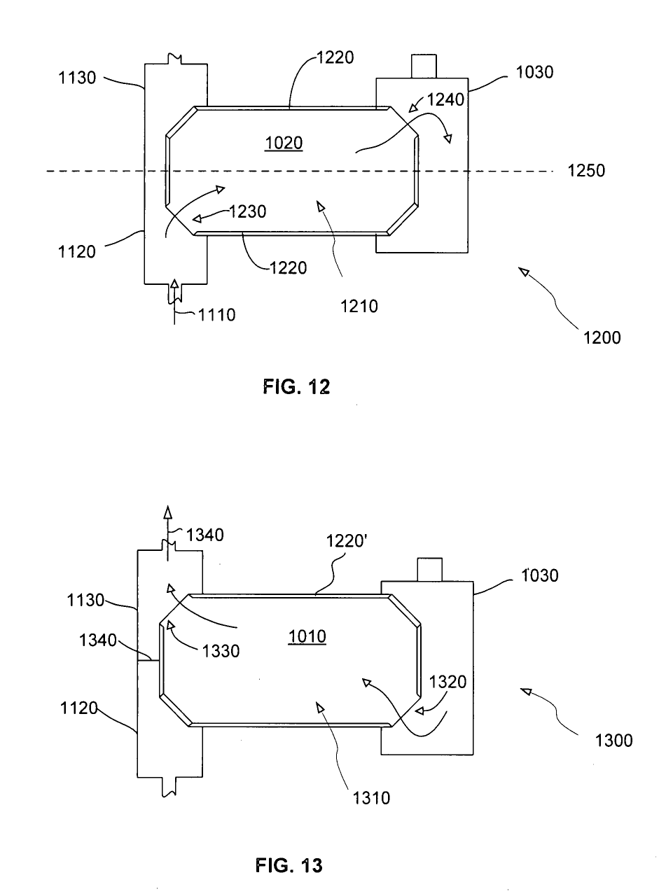

FIG. 12 and FIG. 13 are cross sections of the exhaust system 1000. In FIG. 12, a cross section 1200 is taken along section 12-12 in FIG. 10 through an intake chamber 1210. The intake chamber 1210 is formed between the plate 1020, an exterior wall of the heat exchanger 1010 (not visible in this perspective), and two spacers 1220 that maintain a proper spacing between the exterior wall and the plate 1020. Openings between the spacers 1220 form an inlet 1230 and an outlet 1240 of the intake chamber 1210. The inlet 1230 and the outlet 1240 provide fluid communication between the intake chamber 1210 and the manifold 1120 and the combustion chamber 1030, respectively.

The cross section 1200 is characterized by a transverse plane 1250, seen edge on in FIG. 12, which bisects the heat exchanger 1010 along a longitudinal axis thereof. In this embodiment, the inlet 1230 is below the transverse plane 1250 and the outlet 1240 is above the transverse plane 1250. Placing the inlet 1230 and outlet 1240 on opposite sides of the transverse plane 1250 causes the exhaust gas to traverse a diagonal of the intake chamber 1210.

In FIG. 13, a cross section 1300 is taken along section 13-13 in FIG. 10 through an exit chamber 1310. The exit chamber 1310 is formed between the plate 1020 (not visible in this perspective), another exterior wall of the heat exchanger 1010, and two spacers 1220′. As above, openings between the spacers 1220′ form an inlet 1320 and an outlet 1330 that provide fluid communication with the combustion chamber 1030 and the manifold 1130, respectively. In various embodiments, manifolds 1120 and 1130 consist of a continuous tube separated by a baffle 1340, generally aligned with the transverse plane 1250, configured to prevent fluid communication between manifolds 1120 and 1130. In these embodiments, the manifolds 1120 and 1130 share a common longitudinal axis that is approximately parallel to a plane defined by the plate 1020 and perpendicular to the transverse plane 1250.

In the illustrated embodiment, the inlet 1320 is below the transverse plane 1250 and the outlet 1330 is above the transverse plane 1250. As with the intake chamber 1210, the inlet 1320 and outlet 1330 are on opposite sides of the transverse plane 1250 so that the fluid flow is diagonal across the exit chamber 1310. Arranging the fluid flows along the diagonals of the two chambers 1210, 1310 provides the gases 1110 and 1140 greater opportunity to transfer heat therebetween.

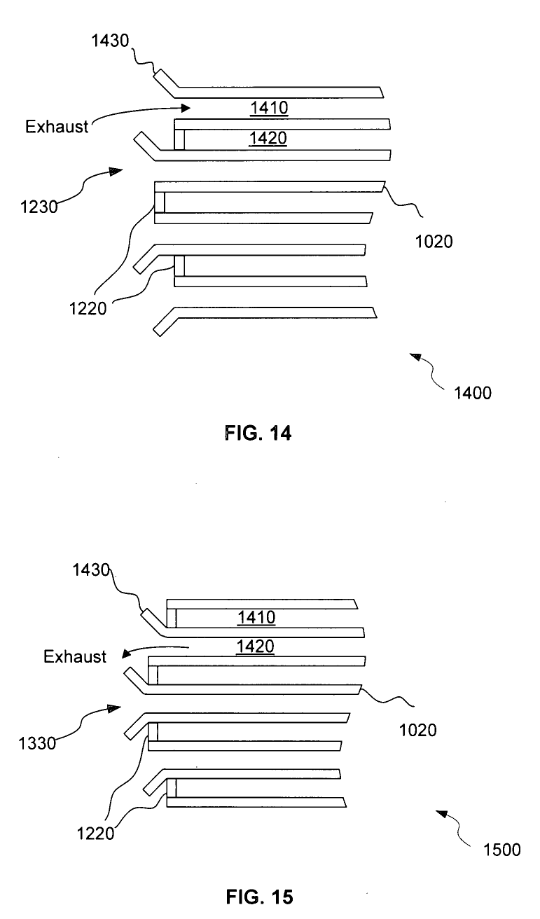

Some embodiments of the heat exchanger 1010 include multiple plates 1020 to form multiple alternating intake and exit chambers 1210, 1310 to provide even greater heat transfer. FIGS. 10 and 11 are also representative of these embodiments. FIG. 14 shows a cross section 1400 taken along the section 14-14 in FIG. 11 of an exhaust system 1000 including multiple plates 1020. Cross section 1400 shows the multiple plates 1020 forming alternating intake chambers 1410 and exit chambers 1420 where the intake chambers 1410 are open to receive exhaust from the manifold 1120. Similar to the above chambers 1210, 1310, each of the chambers 1410, 1420 are formed by two plates 1020 separated by spacers 1220 with openings therebetween to provide inlets and outlets. It will be appreciated that in these embodiments, as well as in the embodiments with only a single set of chambers 1210, 1310, the external walls of the heat exchanger 1010 can also be plates 1020. One method of forming the heat exchanger 1010 is to assemble a stack of alternating plates 1020 and spacers 1220 and to weld or bolt the assembly together.

The manifold 1120 can also include one or more vanes disposed relative to an intake chamber inlet 1230 to reduce resistance to fluid flow near that intake chamber inlet 1230. For example, vanes 1430 extend from the plates 1020 in FIG. 14. The vanes 1430 effectively increase the orifice size of the inlets 1230 to reduce fluid frictions. In various embodiments, vanes 1430 can be joined to the ends of the plates 1020. In other embodiments, the vanes 1430 are integral with the plates 1020 and can be formed by bending the ends of the plates 1020 before assembling the heat exchanger 1010.

FIG. 15 shows a cross section 1500 taken along section 15-15 in FIG. 11 of the exhaust system 1000. Cross section 1500 shows multiple plates 1020 forming alternating intake chambers 1410 and exit chambers 1420 where the exit chambers 1420 are open to vent exhaust to the manifold 1120. The manifold 1130 can also include one or more vanes 1430 disposed relative to the exit chamber outlets 1330 in order to reduce resistance to fluid flow near the exit chamber outlets 1330. For example, a vane 1430 extends from the plate 1020 as shown in FIG. 15. In various embodiments, vanes 1430 also extend from the ends of the plates 1020 at the intake chamber outlets 1240 and the exit chamber inlets 1320 that communicate with the combustion chamber 1030.

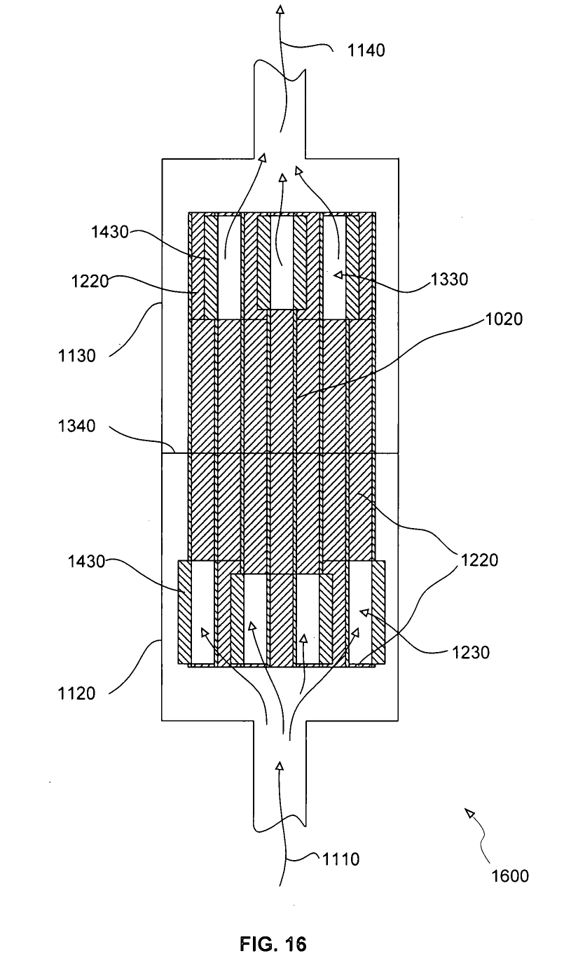

FIG. 16 shows a cross section 1600 taken along the section 16-16 of exhaust system 1000 of FIG. 10. Cross section 1600 shows an end-on view of multiple plates 1020, including the vanes 1430, and multiple spacers 1220 forming alternating intake chambers inlets 1230 and exit chambers outlets 1330. Also depicted in FIG. 16 is the baffle 1340 configured to prevent fluid communication between manifolds 1120 and 1130.

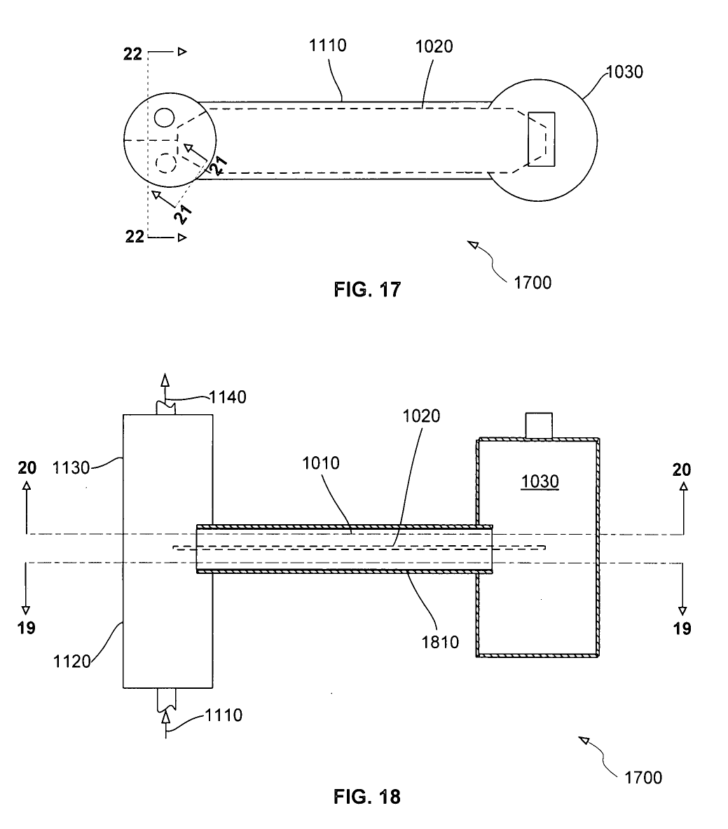

FIGS. 17 and 18 show top and front views, respectively, of another exemplary exhaust system 1700. The exhaust system 1700 is generally similar to the exhaust system 1000 but differs with respect to the orientation of the heat exchanger 1010. Specifically, the heat exchanger is rotated relative to the manifolds 1120, 1130 and/or the combustion chamber 1030 such that the transverse plane 1430 of the heat exchanger 1010 is aligned vertically rather than horizontally. Accordingly, the baffle 1340 is also rotated from horizontal to vertical.

Some embodiments of the exhaust system 1000, 1700 include insulation 1810 around the heat exchanger 1010 and the combustion chamber 1030, as shown in FIG. 18. The use of insulation reduces the amount of energy required to heat the exhaust gas within the combustion chamber 1030. More generally, it will be appreciated that insulation 1810 can be applied individually to any of the heat exchanger 1010, the combustion chamber 1030, and the manifold 1120, or to any combination of these components.

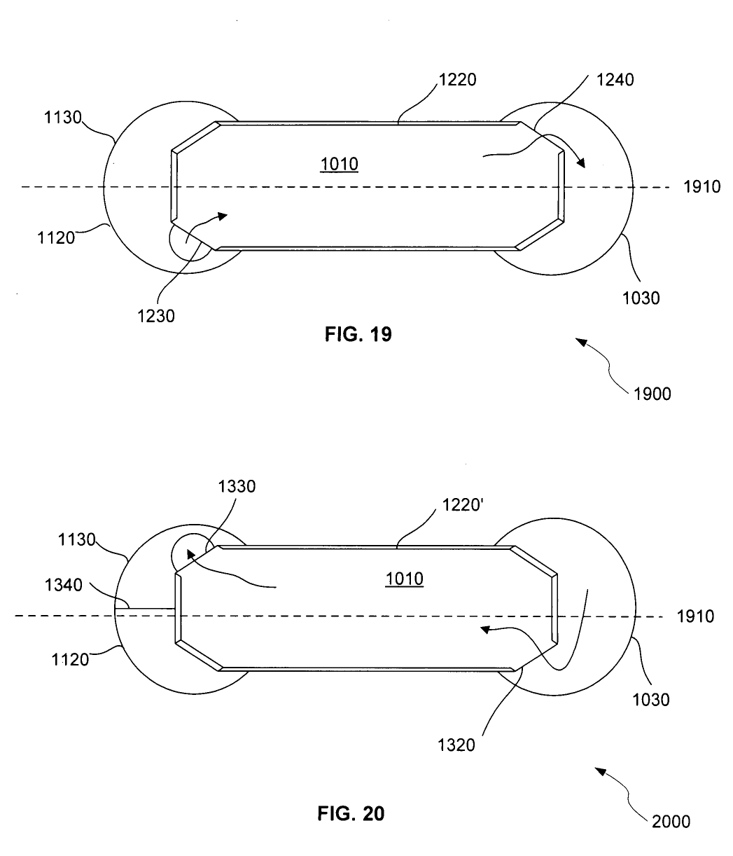

FIGS. 19 and 20 are cross sections of exhaust system 1700. In FIG. 19, a cross section 1900 is taken along section 19-19 in FIG. 18 through an intake chamber 1210, and in FIG. 20 a cross section 2000 is taken along the line 20-20 in FIG. 18 through an exit chamber 1310. As before, the intake chamber 1210 and the exit chamber 1310 are formed between the plate 1020, an exterior wall of the heat exchanger 1010, and spacers 1220. Openings between the spacers 1220 form the inlets 1230, 1320 and outlets 1240, 1330. The intake chamber 1210 is in fluid communication between the manifold 1120 and the combustion chamber 1030. The exit chamber 1310 is in fluid communication between the combustion chamber 1030 and the manifold 1130. In various embodiments, manifolds 1120 and 1130 consist of a continuous tube separated by a vertical baffle 1340.

The heat exchanger 1010 is again characterized by a transverse plane 1910 with the inlet 1230 below the transverse plane 1910 and the outlet 1240 above the transverse plane 1910. Likewise, the inlet 1320 is below the transverse plane 1910 and the outlet 1330 is above the transverse plane 1910. The inlets 1230, 1320 and outlets 1240, 1330 are on opposite sides of the transverse plane 1910 so that fluid flows diagonally through the chambers 1210, 1310.

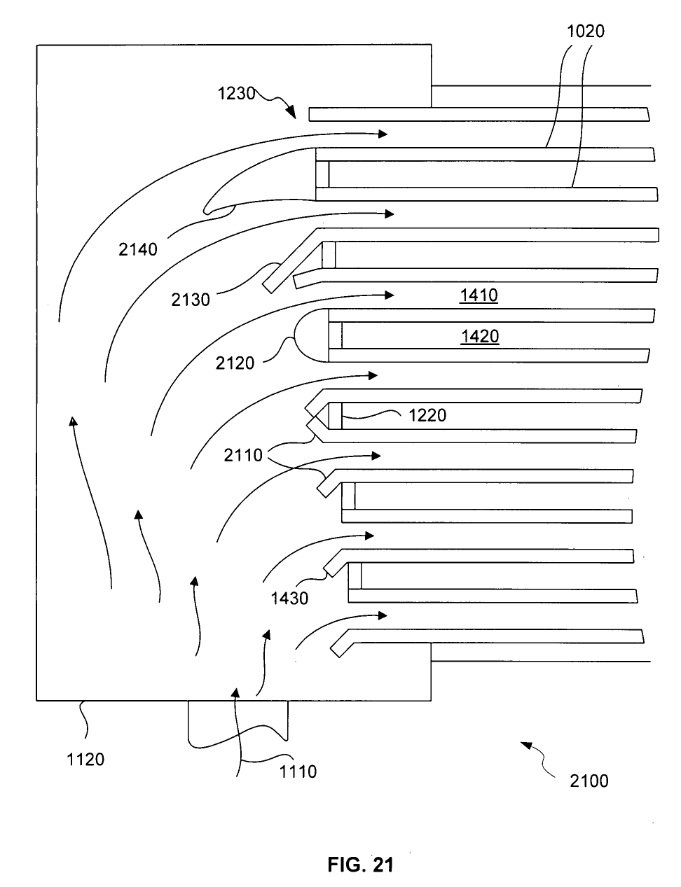

FIG. 21 shows a cross section 2100 taken along the section 21-21 within manifold 1120 of exhaust system 1700. Cross section 2100 shows multiple plates 1020 forming alternating intake chambers 1410 and exit chambers 1420. As above, each chamber 1410, 1420 is formed between two plates 1020 and spacers 1220. FIG. 21 shows a number of alternative concepts for vanes 1430 that can extend from the ends of the plates 1020. In some embodiments, vanes 2110 are disposed on both sides of an opening. In other embodiments, vanes 2120 can be spherically shaped, vanes 2130 can be of different lengths, and vanes 2140 can be aerodynamically shaped. When vanes 1430 on successive openings increasingly extend into a manifold, as in FIGS. 14 and 15, or as the succession of vanes 2120, 2130, and 2140, the vanes 1430 are said to be “feathered.” Feathering further helps to direct flow within the respective manifold to reduce flow friction loses.

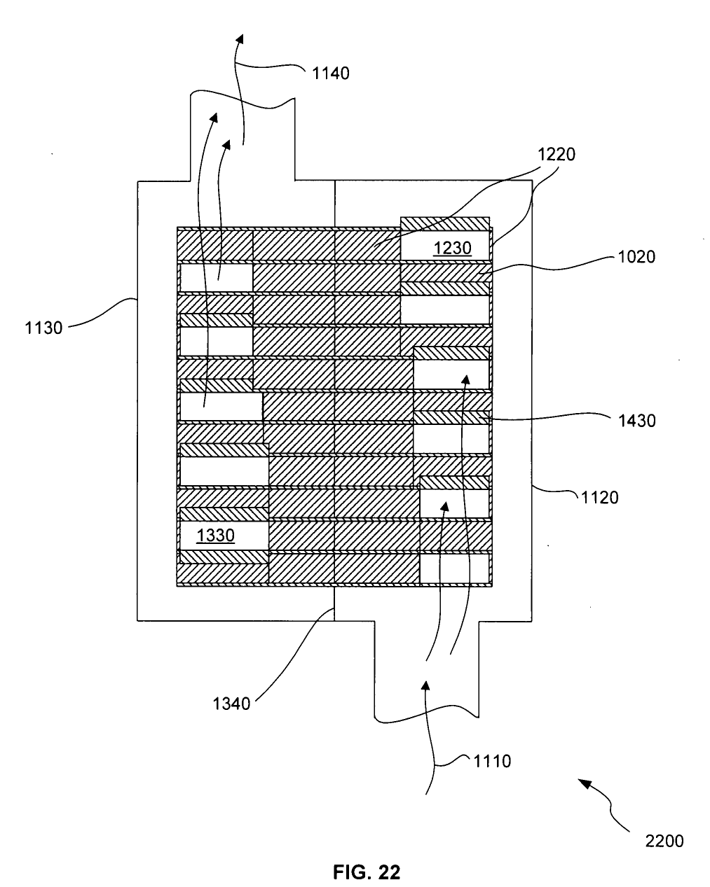

FIG. 22 shows a cross section 2200 taken along section 22-22 of exhaust system 1700. Cross section 2200 shows multiple plates 1020, including vanes 1430, and multiple spacers 1220 forming alternating intake chambers inlets 1230 and exit chambers outlets 1330. Also depicted is baffle 1340 configured to prevent fluid communication between manifolds 1120 and 1130. It will be appreciated that in these embodiments the manifolds 1120 and 1130 define separate but parallel longitudinal axes. These axes are approximately perpendicular to a plane defined by the plate 1020 and parallel to the transverse plane 1250.

Several further advantages of reverse flow heat exchangers 1010 should be noted. For example, these heat exchangers are self-cleaning. It will be appreciated that should a deposit form on an internal surface of one of the plates 1020, the restriction to the flow of exhaust gas around the deposit will tend to cause a local increase in the temperature at the restriction. Eventually, the local temperature increase will reach an ignition temperature of the deposit material, causing the deposit to burn away. Another advantage of the heat exchangers 1010 is that the heated internal surfaces of the chambers 1210, 1310 reduce the resistance to fluid flow through the chambers 1210, 1310 thereby lowering head loss through the exhaust system 1000. Further, it will be appreciated that the heat exchangers 1010 can serve to muffle sound due to the expansions and contractions that the exhaust gas goes through as it passes through successive openings. The muffling effect can be further enhanced by tuning the dimensions of the chambers to behave as resonating chambers. Accordingly, heat exchangers 1010 can replace mufflers on vehicles.

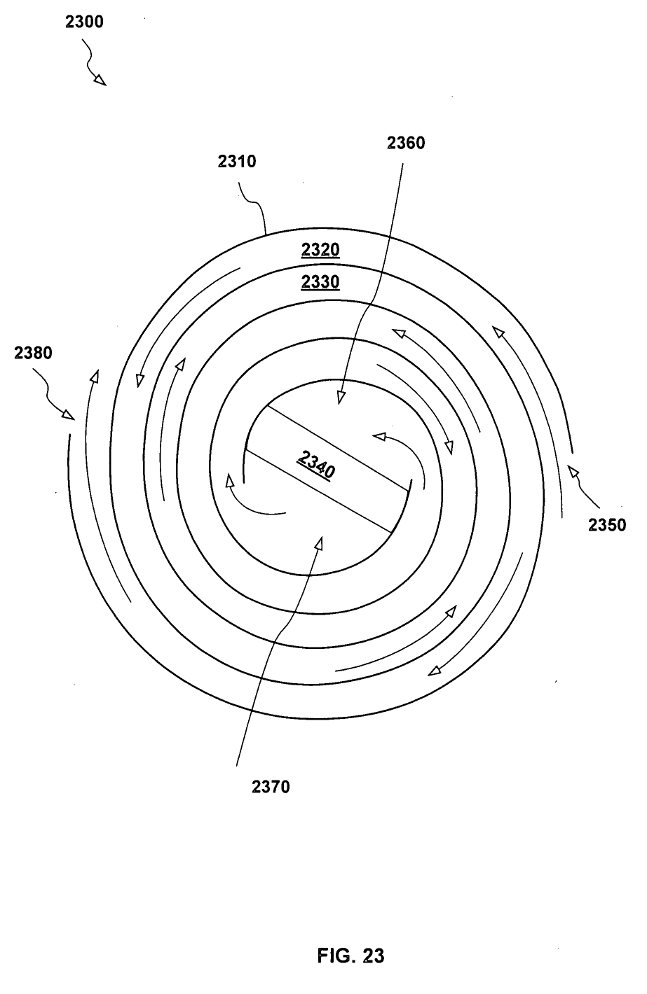

FIG. 23 depicts a cross sectional view of still another embodiment 2300 of the invention comprising a particle burner including a catalyst booster. The cross section depicted is taken perpendicular to a vertical axis of the embodiment 2300. Specifically, the embodiment 2300 comprises a reverse flow heat exchanger 2310 and a gas permeable catalyst 2340. The heat exchanger 2310 comprises two interleaved ducts, an incoming duct 2320 and an outgoing duct 2330. Each duct 2320 and 2330 is spiral-wound around a central volume that includes the catalyst 2340. The ducts 2320 and 2330 are in fluid communication with each other across the central volume and through the catalyst 2340. The incoming duct 2320 comprises an inlet 2350 and the outgoing duct 2330 comprises an outlet 2380. The catalyst 2340 separates the central volume into first and second regions 2360 and 2370. The incoming duct 2320 opens into the first region 2360 and the outgoing duct 2330 opens into the second region 2370.

The inlet 2350 is an opening through which exhaust enters the incoming duct 2320 of the heat exchanger 2310. The exhaust flows through the incoming duct 2320 to the central volume. The exhaust then exits the central volume, travels through the outgoing duct 2330, and leaves the heat exchanger 2310 via the outlet 2380.

As the exhaust traverses the central volume, particles within the exhaust are heated to an ignition temperature and therefore combust. Additionally, gases within the exhaust that result from incomplete fuel combustion are oxidized as they pass through the catalyst 2340. The combustion of the particles and the oxidation of these gases at the catalyst 2340 both give off heat which heats the catalyst 2340 and the exhaust within the central volume. In various embodiments, the heat generated from these exothermic reactions is sufficient to maintain the catalyst 2340 at an operating temperature of approximately 900° C. The ability to operate at high operating temperatures, those above the ignition temperature of the particles, alleviates the need for a particle trap in the exhaust system.

As noted, the exiting exhaust is hotter than the entering exhaust, and as the exhaust travels through outgoing duct 2330, heat is transferred through the duct walls to warm the exhaust in the incoming duct 2320. Recovery of heat in this manner boosts the energy efficiency of the embodiment 2300. It should also be noted that the heat exchanger 2310 acts as insulation for the catalyst 2340, thus making the embodiment 2300 safer.

The catalyst 2340 can comprise a substrate supporting a catalytic material, for example. In various embodiments, the catalytic material is added to a washcoat and applied to the substrate. The washcoat provides increased surface area for the catalytic material. Exemplary substrates comprise a mesh of stainless steel or a porous ceramic, but other suitable materials will be familiar to those skilled in the art. Suitable catalytic materials include platinum, palladium, and rhodium, but other suitable materials will be familiar to those skilled in the art. An exemplary washcoat comprises a mixture of silicon and aluminum, but other suitable materials familiar to those skilled in the art can be employed. Alternatively, the catalyst 2340 can comprise a simple mesh of the catalytic material without a substrate, or a catalytic material deposited directly onto a substrate.

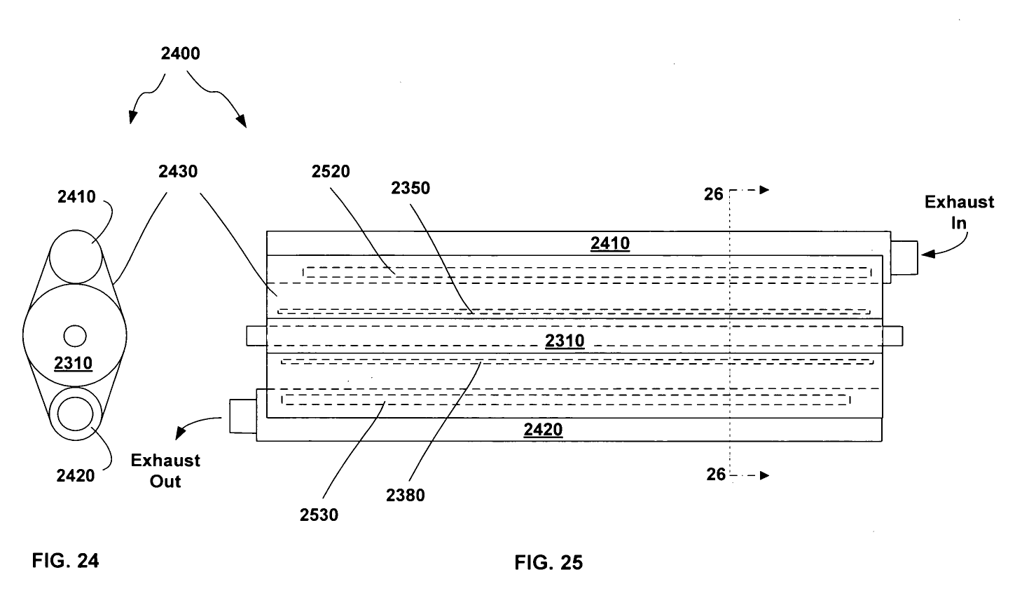

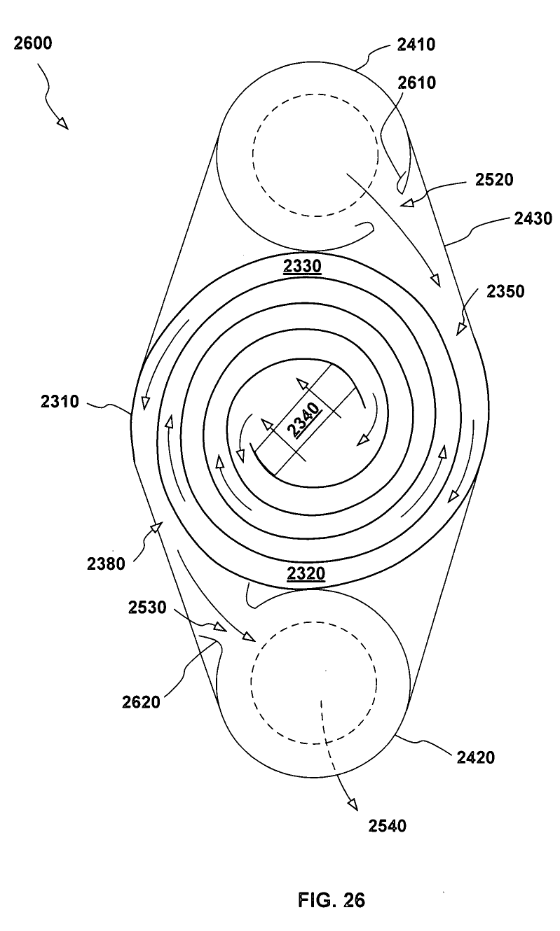

FIGS. 24 and 25 show top and side views 2400 and 2500, respectively, of an exemplary exhaust cleaner 2400 in accordance with an embodiment of the invention. FIG. 26 depicts a cross section 2600 of the exhaust cleaner 2400 taken along section 26-26 of FIG. 25. The exhaust cleaner 2400 is generally applicable and can be used, for example, in conjunction with an automobile, a truck, a boat, or any other machine that employs an internal combustion engine. In any of these applications, the exhaust cleaner 2400 can replace the catalytic converter, particle trap, and/or the muffler.

The exhaust cleaner 2400 comprises a reverse flow heat exchanger 2310, a catalyst 2340, an inlet chamber 2410, an outlet chamber 2420, and an enclosure 2430. The inlet chamber 2410 includes a portal 2520 (see FIG. 26) and the outlet chamber 2420 includes a portal 2530 (FIG. 26). The portals 2520 and 2530 allow the inlet chamber 2410 and the outlet chamber 2420, respectively, to be in fluid communication with the heat exchanger 2310. The enclosure 2430 is disposed around the reverse flow heat exchanger 2310 and the inlet and outlet chambers 2410, 2420. For use with a tractor truck, the exhaust cleaner 2400 is generally approximately seven feet long. Dimensions of the exhaust cleaner 2400 may be designed to allow for easy substitution for the mufflers of existing exhaust systems.

As shown in FIG. 25, exhaust from an internal combustion engine initially enters from one end of the inlet chamber 2410. The exhaust leaves the inlet chamber 2410 through the portal 2520 and enters the heat exchanger 2310. The exhaust spirals in through the heat exchanger 2310, passes through the catalyst 2340, and then spirals out again through the heat exchanger 2310. The exhaust then exits the heat exchanger 2310 through portal 2530 to the outlet chamber 2420 and out of the exhaust cleaner 2400.

In some embodiments, inlet chamber 2410 comprises vanes 2610 that protrude into the inlet chamber 2410 at the portal 2520. Likewise, outlet chamber 2420 can comprise vanes 2620 extending outward at the portal 2530. Vanes and their advantages are discussed elsewhere herein. In some embodiments, the ducts, portals, inlets and outlets may be feathered as also discussed elsewhere herein.

The exhaust cleaner 2400 can also include a means (not shown) for pre-heating the exhaust before the exhaust reaches the catalyst 2340 to permit catalysis to occur at a desired operating temperature, such as 900° C. This may be necessary for a short period of time after a cold engine, for instance. The means for pre-heating may be disposed near the inlet chamber 2410 or anywhere within the flow path between the inlet chamber 2410 and the catalyst 2340. The means for pre-heating can be, for example, a radiation source 810 (FIG. 8), an open flame, or any means for heating discussed elsewhere herein. The exhaust cleaner 2400 can also include a control circuit (not shown) to monitor the catalyst 2340 and to control the means for pre-heating.

Typically, the enclosure 2430, the heat exchanger 2310, and the inlet and outlet chambers 2410 and 2420 are made from stainless steel, titanium, and/or ceramics, but other suitable materials will be familiar to those skilled in the art. Typically, the walls separating the ducts 2320, 2330 are constructed of a material with a high thermal conductivity, such as a metal, to provide good heat transfer from the outgoing duct 2330 to the incoming duct 2320.

An exemplary method for manufacturing the exhaust cleaner 2400 comprises attaching opposite sides of the catalyst 2340 to the ends of two metal sheets. The metal sheets are then wrapped around the catalyst 2340 to form the ducts 2320, 2330 of the reverse flow heat exchanger 2310. A spacer placed at either side of one of the two sheets can be used to maintain the proper spacing between the ducts 2320, 2330. After the sheets have been wrapped around catalyst 2340, the inlet and outlet chambers 2410 and 2420 can be attached to the reverse flow heat exchanger 2310. An enclosure can then be wrapped around the entire assembly, or further metal sheets can be attached to span between the chambers 2410, 2420 and the reverse flow heat exchanger 2310 to fully enclose the flow path of the exhaust. Lastly, end caps can be attached to the assembly to seal the ends.

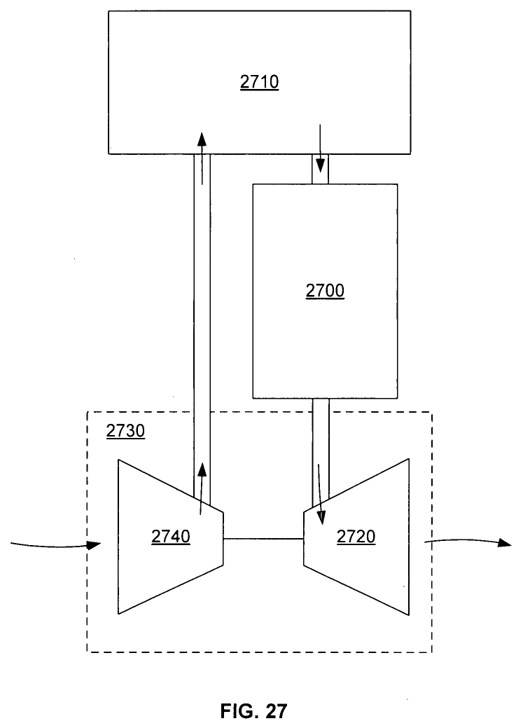

FIG. 27 depicts a schematic representation of a particle burner 2700 disposed between an engine 2710 and a turbine 2720 of a turbo charger 2730 in accordance with an embodiment of the invention. In various embodiments, the particle burner 2700 comprises the exhaust cleaner 2400 (FIG. 24). As shown in FIG. 27, air enters the turbo charger 2730 and is compressed by an impeller 2740 of the turbo charger 2730 before entering the engine 2710. Exhaust from the engine 2710 passes through the particle burner 2700 before returning to the turbo charger 2730 where the exhaust powers the turbine 2720.

Since the turbine 2720 operates at a relatively high pressure, i.e., between about two and ten atmospheres, the pressure within the particle burner 2700 is also elevated relative to the ambient air pressure. A higher pressure within the particle burner 2700 is beneficial because a catalyst within the particle burner 2700, such as catalyst 2340 (FIG. 23), oxidizes the gaseous products of incomplete combustion more efficiently. Thus, the catalyst can employ less catalytic material to achieve similar results as a catalyst that operates at a lower pressure. In some embodiments, the weight of catalytic material in the catalyst (e.g., catalyst 2340) is about 20% of the weight of catalytic material in a catalyst disposed in an exhaust system after the turbo charger 2730. It is noted that the higher pressure within the particle burner 2700 also allows the reverse-flow heat exchanger of the particle burner 2700 to operate more efficiently, thereby allowing the reverse-flow heat exchanger to be smaller, lowering the cost to manufacture the particle burner 2700.

Commonly, turbo chargers are tuned to the pulsations within the exhaust, though some turbo chargers are tuned to a flattened continuous flow and these turbo chargers tend to be more efficient. Since the particle burner 2700 acts like a muffler, and flattens out the pulsations within the exhaust, placing the particle burner 2700 before the turbine 2720 can make the turbo charger 2730 operate more efficiently.

Additionally, the work that can be extracted from the exhaust by the turbine 2720 increases as both the temperature and the pressure differences across the turbine 2720 increase. Since the particle burner 2700 raises the temperature of the exhaust in front of the turbine 2720, this increases the amount of work that can be extracted by the turbine 2720.

Similarly, since the particle burner 2700 acts as a muffler, placing the particle burner 2700 in front of the turbine 2720 mitigates or eliminates the need for a muffler after the turbo charger 2730, and removing or reducing the muffler after the turbo charger 2730 lowers the pressure in the exhaust system behind the turbine 2720. This, in turn, creates a greater pressure drop across the turbine 2720 for a still further improvement in available work. The increased amount of work that can be extracted by the turbine 2720 can be used by the impeller 2740 to further compress the incoming air, but may also be drawn off for other purposes. Further compressing the air can increase the power available from the engine 2710, increasing the overall efficiency of the system. It is noted that a reduced muffler may still be used placed after the turbo charger 2730 to muffle noise produced by the turbo charger 2730.

It should be noted that placing the particle burner 2700 between the engine 2710 and the turbo charger 2730 creates a longer air path between these two components. This longer air path can create an increased “turbo lag” which may reduce the efficiency of the turbo charger 2730. In various embodiments, a control system (not shown) can compensate for the reduced efficiency of the turbo charger 2730. In some embodiments, the control system is also coordinated with a bypass system (not shown) of the turbo charger 2730 that allows excess exhaust to bypass the turbo charger 2730. In some further embodiments, some of the compressed air from the impeller 2740 is directed away from the engine 2710 and added before the turbine 2720, under the control of the control system, to further flatten the pulsations of the exhaust, and/or support the exhaust pressure, to reduce the turbo lag.

It will also be appreciated that providing the particle burner 2700 between the engine 2710 and the turbo charger 2730 allows for various design trade-offs between engine power, engine efficiency, and engine size. Since the turbo charger 2730 can extract more work from the exhaust, the engine 2710 can be made smaller, lighter, and less expensive to manufacture while keeping the power from the engine 2710 the same. Alternately, some gain in power can be traded for a gain in engine efficiency.

In the foregoing specification, the present invention is described with reference to specific embodiments thereof, but those skilled in the art will recognize that the present invention is not limited thereto. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A system comprising:
an engine;
a turbo charger including an impeller and a turbine; and
a particle burner disposed between the engine and the turbine and configured to receive exhaust from the engine.

2. The system of claim 1 wherein the particle burner comprises a catalyst.

3. The system of claim 1 wherein the particle burner comprises a reverse flow heat exchanger.

4. The system of claim 3 wherein the reverse flow heat exchanger includes a first duct interleaved with a second duct, each duct spiral-wound around a central volume, the first and second ducts in fluid communication with each other across the central volume.

5. The system of claim 4 further comprising a gas permeable catalyst disposed within the central volume and separating the central volume into first and second regions, the first duct opening into the first region and the second duct opening into the second region.

6. A vehicle comprising:
an engine;
a turbo charger including an impeller and a turbine; and
a particle burner disposed between the engine and the turbine and configured to receive exhaust from the engine.

7. The vehicle of claim 6 wherein the engine comprises a diesel engine.

8. The vehicle of claim 6 wherein the engine comprises a gasoline engine.

9. The vehicle of claim 6 wherein the particle burner comprises a catalyst.

10. The vehicle of claim 6 wherein the particle burner comprises a reverse flow heat exchanger.

11. The vehicle of claim 10 wherein the reverse flow heat exchanger includes a first duct interleaved with a second duct, each duct spiral-wound around a central volume, the first and second ducts in fluid communication with each other across the central volume.

12. The vehicle of claim 11 further comprising a gas permeable catalyst disposed within the central volume and separating the central volume into first and second regions, the first duct opening into the first region and the second duct opening into the second region.

13. A method comprising:
burning fuel in an engine to produce an exhaust including particles;
using the exhaust to drive a turbine of a turbo charger; and
heating the exhaust to a combustion temperature of the particles before using the exhaust to drive the turbine.

14. The method of claim 13 wherein heating the exhaust includes generating heat by catalyzing the further combustion of gaseous products of incomplete combustion.

15. The method of claim 13 wherein heating the exhaust includes passing the exhaust through a reverse flow heat exchanger.

16. The method of claim 15 wherein the reverse flow heat exchanger comprises two interleaved ducts.

17. The method of claim 16 wherein the ducts of the reverse flow heat exchanger are spiral-wound.
